(19) United States
(12) Patent Application Publication
(10) Pub. No.: US 2010/0066764 A1
(43) Pub. Date: Mar. 18, 2010

(54) SELECTIVE CHARACTER MAGNIFICATION ON TOUCH SCREEN DEVICES

(75) Inventor: Wail Mohsen Refai, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/233,386

(22) Filed: Sep. 18, 2008

(51) Int. Cl. G09G 5/00

(52) U.S. Cl. 345/660

(57) ABSTRACT

Selectively magnifying a set of characters on a touch screen of a computing device. Input is received from a user via the touch screen. A target character is identified, along with a plurality of other characters, based on the received input. In some embodiments, the plurality of other characters includes characters adjacent to the target character, or symbols appropriate for the target character. The target character and plurality of other characters are magnified either by touching the screen or by getting in close proximity from the screen to enable the user to accurately select one or more intended characters from the magnified characters.

### BACKGROUND

Small computing devices such as mobile telephones often have touch screens or touch sensitive displays for entering data on the computing devices. For example, some computing devices display a QWERTY-style or any other type of keyboard as the user chooses for selecting characters with a stylus or a user's finger or thumb. However, due in part to the small screen sizes of these computing devices, the displayed characters are very small, and selecting the characters is often laborious and prone to error. The character selection process on existing touch screen computing device is often unsatisfactory. With the increasing popularity of one-handed data entry (e.g., sending text messages or emails while performing other tasks), the existing systems for inputting data on touch screen devices are limited.

Existing systems lack a mechanism for enabling accurate and fast selection of characters via touch screens on small computing devices.

### SUMMARY

Embodiments of the invention selectively magnify characters on a touch screen of a computing device. Input is received from a user via the touch screen. A target character is identified, along with a plurality of other characters, based on the received input. The target character and plurality of other characters are magnified to enable the user to accurately select an intended character. The target character is visually distinguished from the plurality of other characters. In some embodiments, the plurality of other characters includes characters surrounding the target character or symbols.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a user interacting with a computing device.

FIG. 2 is an exemplary flow chart illustrating the selection and magnification of characters during sustained input pressure from the user on a touch screen.

FIG. 3 is an exemplary flow chart illustrating the selection and magnification of a target character and symbols.

FIG. 4 is an exemplary flow chart illustrating the entry of the word KEY via a touch screen in accordance with aspects of the invention.

FIG. 5 illustrates an exemplary mobile device with a touch screen displaying a QWERTY-style keyboard.

FIG. 6 illustrates an exemplary mobile device with a touch screen displaying a set of magnified characters including a target character.

FIG. 7 illustrates an exemplary mobile device with a touch screen displaying a set of magnified characters including a target character and relevant symbols.

FIG. 8 illustrates an exemplary mobile device with a touch screen displaying a set of magnified uppercase letters and a symbol for displaying lowercase versions of the letters.

Corresponding reference characters indicate corresponding parts throughout the drawings.

### DETAILED DESCRIPTION

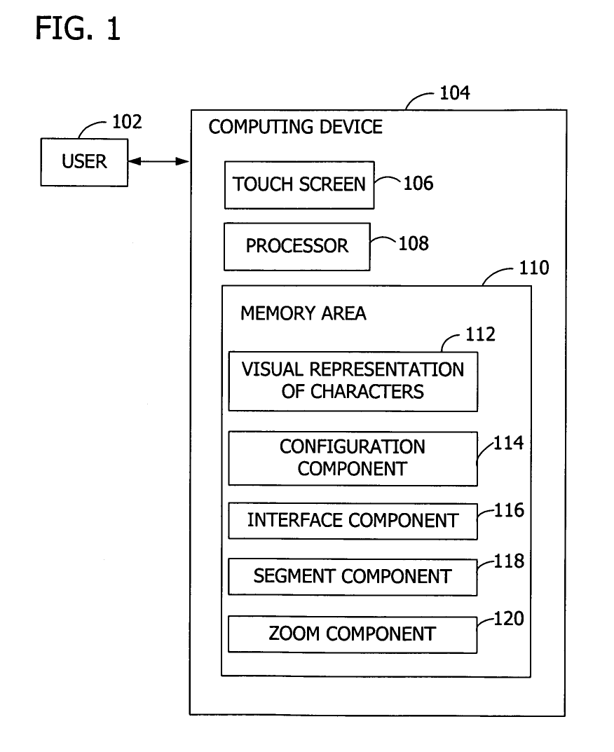

Embodiments of the invention provide a character input mechanism that is accurate and easy for a user 102 of a computing device 104 having a touch screen 106 such as shown in FIG. 1. In some embodiments, a set of characters near a contact point by the user 102 on the touch screen 106 is selected and magnified. The user 102 confirms or corrects the selection of an intended character. The user 102 provides input via a finger, thumb, stylus, or any pointing device providing tactile or non-tactile input (e.g., hover). Aspects of the invention reduce input error and enable users (e.g., those with large fingers) to use applications on the computing device 104 (e.g., a mobile telephone) such as messaging, browsing, and search) with one hand. Further, aspects of the invention are operable to improve the quality of input entry with any screen size on the computing device 104 while maintaining high accuracy of data entry.

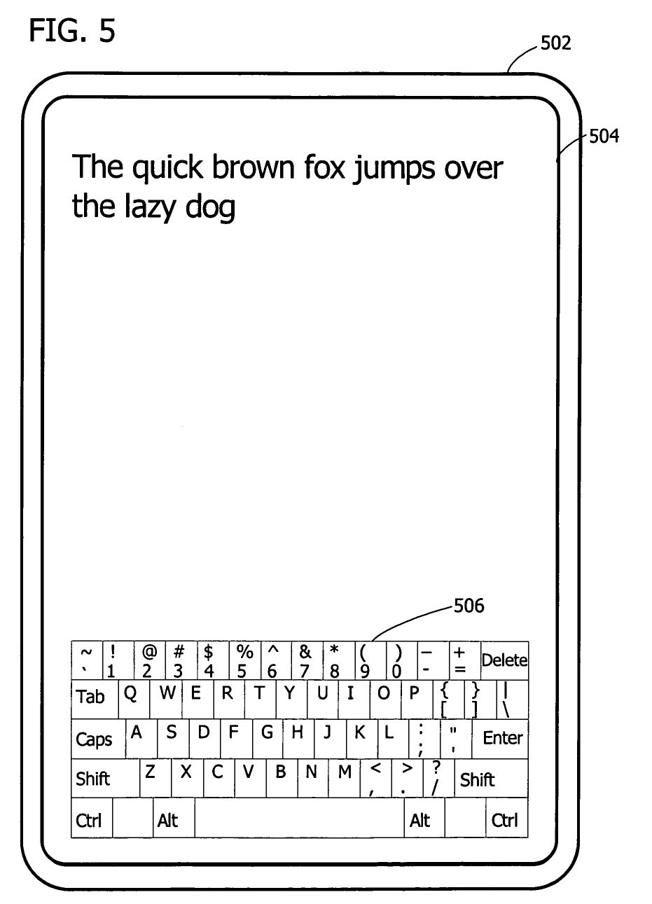

While some embodiments of the invention are illustrated and described herein with reference to a mobile computing device 502 (e.g., see FIG. 5), aspects of the invention are operable with any touch screen device that performs the functionality illustrated and described herein, or its equivalent. For example, embodiments of the invention are operable with a desktop computing device, a laptop computer, and other computing devices to improve the accuracy and ease of text entry. Further, aspects of the invention are operable are not limited to the touch screens or pressure-sensitive displays described here. Rather, embodiments of the invention are operable with any screen or display designed to detect the location of a selection at or near the surface of the screen. In such embodiments, pressure or actual touch is not required, and the user 102 merely hovers a finger over the desired character.

Referring again to FIG. 1, an exemplary block diagram illustrates the user 102 interacting with the computing device 104. The computing device 104 includes the touch screen 106, a processor 108, and a memory area 110. The memory area 110, or other computer-readable medium, stores a visual representation 112 of characters. The characters include, for example, numbers, symbols, letters in any language, or the like. The memory area 110 further stores computer-executable components including a configuration component 114, an interface component 116, a segment component 118, and a zoom component 120. The configuration component 114 enables the user 102 of the computing device 104 to provide magnification settings associated with the visual representation 112 of one or more characters. The interface component 116 displays the visual representation 112 of the characters on at least a portion of the touch screen 106. The interface component 116 further receives input (e.g., a first input) from the user 102 via the touch screen 106. In some embodiments, the computing device 104 detects an object hovering near the touch screen 106, but not touching the touch screen 106. The segment component 118 identifies a target character from the displayed characters based on the input received by the interface component 116. The target character corresponds to the location of the input by the user 102 on the touch screen 106. The segment component 118 further selects a subset of the characters based at least on the identified target character. The selected subset includes the identified target character. In some embodiments, the subset of characters includes one or more of the characters immediately adjacent to the target character (e.g., a ring of characters surrounding to the target character).

In other embodiments, the subset of characters includes only those nearby or adjacent letters that are verbally logical. For example, the segment component 118 accesses a dictionary to identify the word possibilities for a set of characters input by the user 102. The segment component 118 only selects the adjacent or nearby letters that would be part of a word from the dictionary.

In some embodiments, the interface component 116 detects a direction of the input relative to the visual representation 112 of the characters. For example, the direction may be detected or calculated based on pressure differences on the touch screen 106, or based on a perceptible slide of the user's finger or stylus. The direction, in some embodiments, is detected or calculated relative to the location of the input on the touch screen 106. The segment component 118 selects the subset of the plurality of characters based on the detected direction. For example, if the detected location of the input from the user 102 is the letter ‘F’ on a QWERTY-style keyboard and the direction is a vector heading above and to the left of the detected location, the subset of characters includes more characters above and to the left of ‘F’ and fewer characters below and to the right.

The zoom component 120 magnifies the subset of characters selected by the segment component 118 according to the magnification settings from the configuration component 114. In some embodiments, the zoom component 120 visually distinguishes the target character from the other characters in the magnified subset. The interface component 116 receives another input (e.g., a second input) from the user 102 via the touch screen 106. The segment component 118 selects at least one character from the magnified subset of characters based on the second input received by the interface component 116.

In some embodiments, the first input and the second input are separate and distinct touches of the finger to the touch screen 106. In other embodiments, the first input is the user 102 holding a finger to the touch screen 106 (e.g., providing sustained input at one location), while the second input is the user 102 releasing the finger from the touch screen 106 (e.g., releasing the sustained input at the same or other location).

In some embodiments, there is only one input touch of the finger per character to the touch screen 106. This is accomplished with a sensitive screen (e.g., capacitive or other similar technology) such as touch screen 106. When the user 102 gets a finger close to the screen (e.g., a few millimeters from the screen), the screen magnifies the closest character to the finger of the user 102 and the adjacent characters. It also distinguishes the closest character from its surrounding characters (e.g., bold, framed, colored, etc). Then, the user 102 touches either the “bold” character or one of the surroundings to be entered as the intended text character. This way, the user 102 only touches the screen one time per every input character.

The magnification settings enable the user 102 to configure properties related to, for example, the selection of the subset of characters, the level of magnification (e.g., size of the characters), and any display options associated with the magnification (e.g., partially or completely overlay the zoomed characters on the keyboard). Other magnification settings are within the scope of aspects of the invention. For example, some of the magnification settings include an option for linear magnification or non-linear magnification such as a fish bowl or concave/convex appearance of the keys relative to the target character.

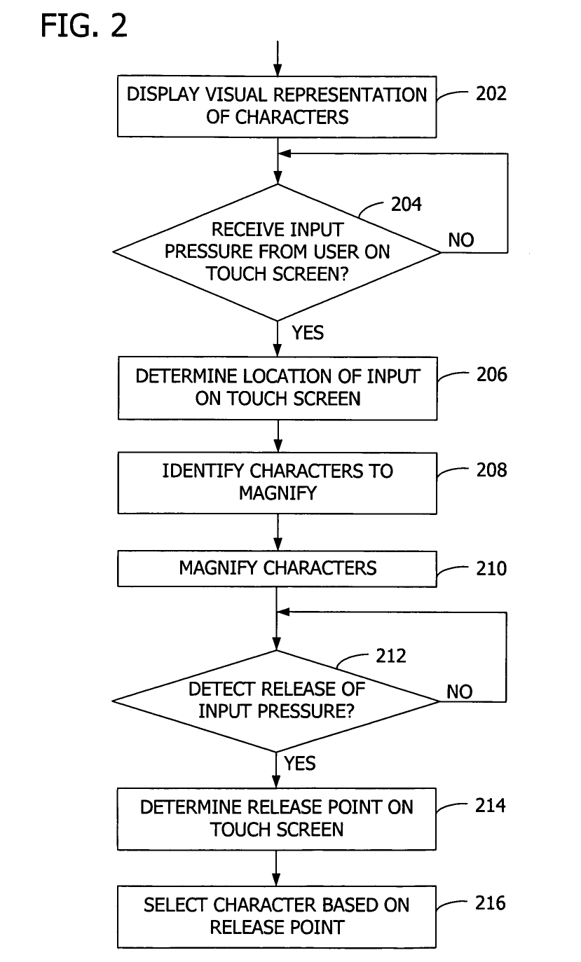

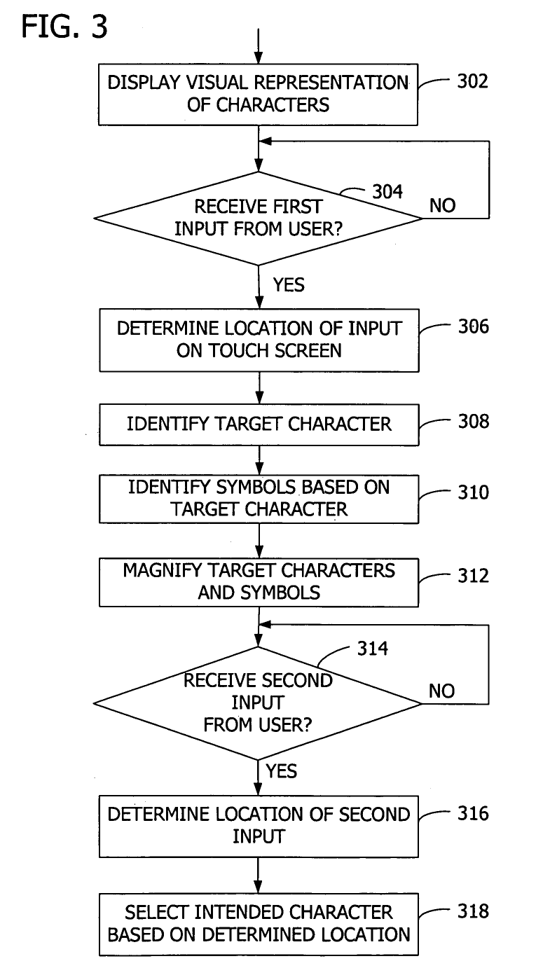

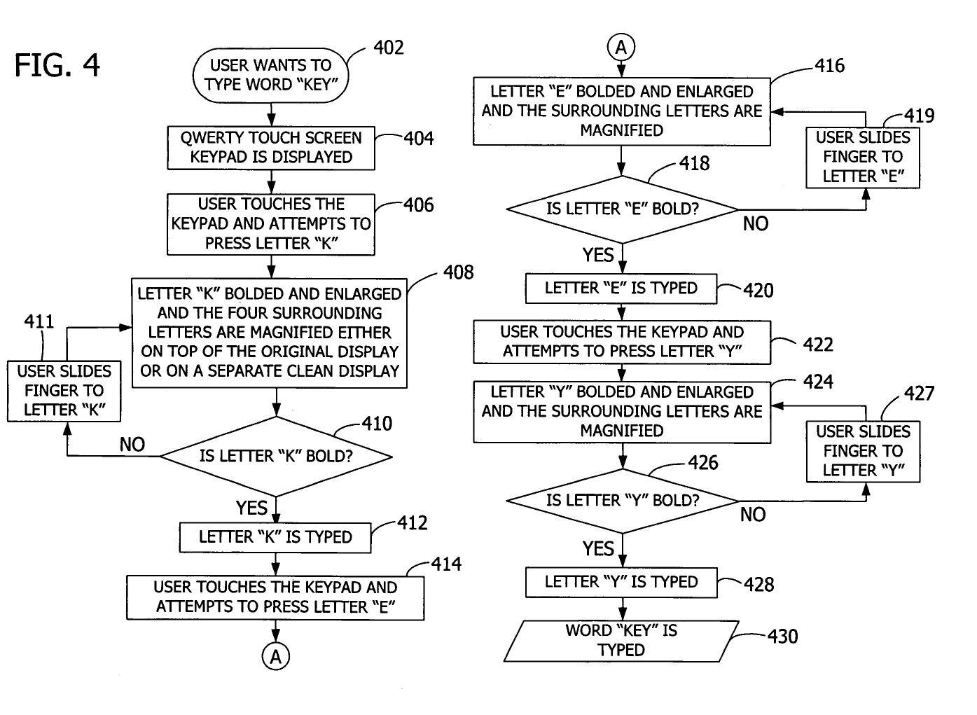

In an embodiment, the processor 108 is transformed into a special purpose microprocessor by executing computer-executable instructions or by otherwise being programmed. For example, the processor 108 executes computer-executable instructions for performing the operations illustrated in FIG. 2, FIG. 3, and FIG. 4. In the embodiment of FIG. 2, the processor 108 is programmed to display at 202 the visual representation 112 of one or more characters on at least a portion of the touch screen 106 associated with the computing device 104. If sustained input pressure is received from the user 102 at 204 via contact at or near the surface of the touch screen 106, a location of the input is determined at 2 relative to the displayed visual representation 112 of the plurality of characters. The sustained input pressure is provided by holding, for example, the user's finger, a stylus, or any other pointing device against the touch screen 106. The characters to magnify are identified at 208 based at least on the determined location. For example, the identified characters include a target character corresponding to the determined location of the input and a plurality of characters surrounding the target character. The identified characters are magnified at 210, with the target character being visually distinguished from the other characters. For example, the visual distinction includes formatting such as magnifying the target character at a higher level than the other characters selected for magnification. The visual distinction also includes bolding, highlighting, color changing, italicizing, underlining, framing, and other formatting. If the computing device 104 detects a release of the sustained input pressure at 212, a location of a release point relative to the magnified subset of characters is determined at 214. One of the magnified subset of characters is selected at 216 as an intended character based on the determined location.

In the example of FIG. 2, the user 102 provides sustained input pressure to prompt the magnification and selection of the intended character. In other embodiments, such as in FIG. 3, the user 102 provides separate inputs to perform the magnification and selection.

Referring next to FIG. 3, an exemplary flow chart illustrates the selection and magnification of a target character and symbols using separate inputs from the user 102. The visual representation 112 of a plurality of characters is displayed at 302 on at least a portion of the touch screen 106. If a first input is received from the user 102 via the touch screen 106 at 304, a location of the received first input relative to the displayed characters is determined at 306. A target character is identified at 308 from the displayed plurality of characters based at least on the determined location. One or more non-alphanumeric characters are selected at 310 based at least on the identified target character. For example, the non-alphanumeric characters include symbols or representation such as punctuation symbols or symbols corresponding to functions or concepts in the scientific field such as mathematical symbols, computer logic symbols, electrical engineering notation, chemical symbols, or other symbols.

In some embodiments, the non-alphanumeric characters are selected based on one or more of the following: linguistic probabilities associated with the target character, frequency of use of the non-alphanumeric characters, and whether the target character is a letter or a number. The linguistic probabilities contemplate selecting the non-alphanumeric characters in conjunction with a dictionary and/or grammatical reference. For example, if the target character completes a word input by the user 102 and if the sentence containing the word is grammatically complete, one of the non-alphanumeric characters selected includes punctuation such as a period, colon, semi-colon, or comma. In another example, if the dictionary indicates that the input characters may be part of a hyphenated word, the non-alphanumeric characters include a hyphen. The non-alphanumeric characters may further include accent marks such as a grave. In yet another example, a closing parenthesis or bracket may be selected if an opening parenthesis or bracket was previously selected by the user 102. In a further example, the at symbol (@) may be selected if the characters previously selected by the user 102 correspond to an electronic mail alias from a contacts list accessible to the computing device 104.

The frequency of use of the non-alphanumeric characters corresponds to a popularity of the characters. For example, brackets or braces may be used less frequently than periods or parentheses. As such, the brackets or braces may not be included in some embodiments. In another embodiment, if the target character is a number, mathematical symbols may be selected to be magnified.

The target character and non-alphanumeric characters are magnified at 312 relative to the unselected characters. In some embodiments, the magnified target character is visually distinguished from the magnified non-alphanumeric characters. For example, the target character is magnified at a first magnification level and the non-alphanumeric characters are magnified at a second magnification level, where the first magnification level is greater than the second magnification level.

A second input is received from the user 102 via the touch screen 106 at 314. A location of the received second input relative to the magnified target character and the magnified non-alphanumeric characters is determined at 316. Either the target character or one of the magnified plurality of non-alphanumeric characters is selected at 318 as the intended character based on the determined location or other factors.

In some embodiments, the selected plurality of non-alphanumeric characters may be modified based at least on the intended character. In this example, the user 102 provides a first input to select the target character, and then provides a second input to select the intended character. After receipt of the intended character, the computing device 104 modifies the set of non-alphanumeric characters. For example, an open parenthesis may be displayed and magnified. Then if the intended character completes a word, the computing device 104 may remove the parenthesis from the magnified symbol list and include a comma, period, colon or semi-colon in its place. Other embodiments and mechanisms for selecting the non-alphanumeric characters are contemplated and within the scope of the invention.

Some embodiments automatically remove the magnification upon selection of the intended character by the user 102, and re-display the original keyboard, keypad, or another set of characters for selection. In contrast, some embodiments (not shown) support entry of multiple characters from the magnified subset of characters. For example, one of the magnified characters includes a terminate symbol corresponding to a terminate or “close” command for removing the magnification of the characters. In such an example, the user 102 selects multiple characters from the magnified subset, then selects the termination symbol (e.g., as a third input) to indicate that no further characters will be selected from the subset.

Referring next to FIG. 4, exemplary flow chart illustrates the entry of the word KEY via the touch screen 106 in accordance with aspects of the invention. The user 102 desires to enter the word KEY at 402. A QWERTY-style keypad is displayed at 404 on the touch screen 106. The user 102 touches the keypad and attempts to press the letter K at 406. The letter K is bolded and enlarged (e.g., magnified) and the surrounding letters on the keypad are magnified either on top of the displayed keypad or in the place of the displayed keypad at 408. If the letter K is not bold at 410, the user 102 slides a finger to the letter K at 411. If the letter K is bold at 410, the letter K is typed at 412.

The user 102 touches the keypad and attempts to press the letter E at 414. The letter E is then bolded and enlarged along with the surrounding letters at 416. If the letter E is not bold at 418, the user 102 slides a finger to the letter E at 419. If the letter E is bold at 418, the letter E is typed at 420. The user 102 touches the keypad and attempts to press the letter Y at 422. The letter Y is then bolded and enlarged along with the surrounding letters at 424. If the letter Y is not bold at 426, the user 102 slides a finger to the letter Y at 427. If the letter Y is bold at 426, the letter Y is typed at 428. As a result, the word KEY is typed at 430.

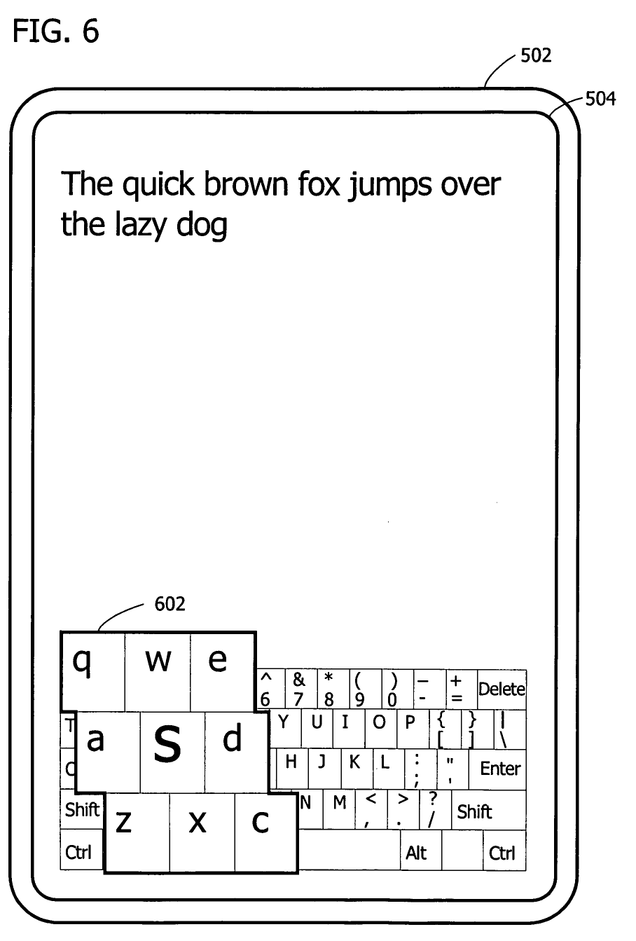

Referring next to FIG. 5, an exemplary mobile computing device 502 with a touch screen 504 displays, as an example, a QWERTY-style keyboard 506. Aspects of the invention are applicable with other keyboard styles (e.g., compact QWERTY keyboard style, telephone or 12-key keypad style, etc). Other embodiments (not shown) show a portion of the keyboard 506 (e.g., a subset of the characters from the keyboard 506) or a numeric keypad (e.g., a 9-, 10-, 11-, or 12-digit numeric keypad). Referring next to FIG. 6, the mobile computing device 502 with the touch screen 504 from FIG. 5 displays a set 602 of magnified characters including the target character. In the example of FIG. 6, the target character (e.g., the character corresponding to the location of the input from the user 102) is the letter S. The set 602 of magnified characters includes the letter S and the immediately adjacent characters on the keyboard 506 (e.g., the letters Q, W, E, A D, Z, X, and C). For example, this set of letters is magnified and overlaid on the displayed QWERTY keyboard as part of the keyboard 506 or to be overlaid over the entire keyboard 506.

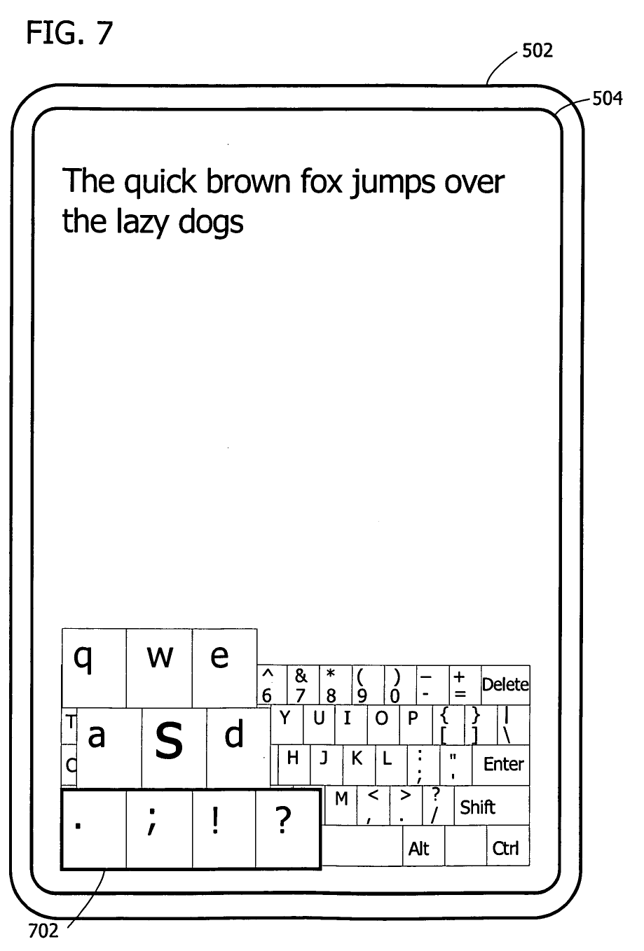

Referring next to FIG. 7, the mobile computing device 502 with the touch screen 504 from FIG. 6 displays the set of magnified characters including the target character and relevant symbols 702. In the example of FIG. 7, the user 102 has selected the letter S not only as the target character, but as the intended character with a second input (e.g., a separate, discrete “tap,” or a release of the finger from the touch screen 504 after a “tap and slide” input). Upon receipt of the second input, the computing device 104 determines that the intended character S completes a word (e.g., dogs), and completes a sentence (e.g., The quick brown fox jumps over lazy dogs). The computing device 104 then replaces the magnified characters Z, X, and C with the symbols 702 selected based on the completed word and sentence. In the example of FIG. 7, the symbols 702 include a period, semicolon, exclamation point, and a question mark. In some embodiments, the symbols 702 may be ordered left-to-right based on a grammatical frequency of use of the symbols 702 in a particular language.

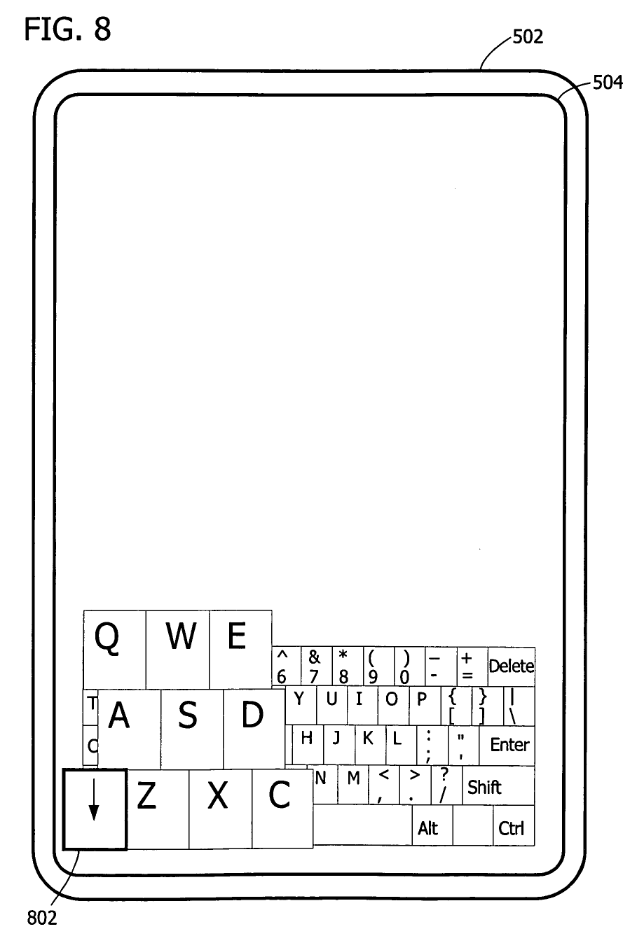

Referring next to FIG. 8, the mobile computing device 502 with a touch screen 504 from FIG. 5 displays a set of magnified uppercase letters and a symbol 802 for requesting display of lowercase versions of the letters. In the example of FIG. 8, one of the magnified characters includes a symbol (e.g., an up arrow) for displaying uppercase versions of the letters from FIG. 5. The user 102 has selected this symbol, and the letters are displayed in FIG. 8 in uppercase, along with the symbol 802 for requesting display of lowercase versions of the letters. The user 102 is now able to select an uppercase version of the letters for entry. When a lowercase version of the letters is desired, the user 102 may select the down arrow symbol 802, which corresponds to a command for displaying lowercase versions of the magnified characters.

### Exemplary Operating Environment

A computer or computing device 104 such as described herein has one or more processors or processing units, system memory, and some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

The embodiments illustrated and described herein as well as embodiments not specifically described herein but within the scope of aspects of the invention constitute exemplary means for improving the accuracy of character input by the user 102 on the mobile computing device via the touch screen 106 or 504, and exemplary means for determining the plurality of characters directly or indirectly surrounding the target character (e.g., immediately adjacent, or with a character inbetween).

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for accurate input entry on a mobile device, said system comprising:
a memory area for storing a visual representation of a plurality of characters; and
a processor programmed to:
display the visual representation of a plurality of characters on at least a portion of a touch screen associated with the mobile device;
receive sustained input pressure from a user via the touch screen;
determine a location of the received, sustained input pressure relative to the displayed visual representation of the plurality of characters;
identify a subset of the plurality of characters based on said determining, said identified subset including a target character corresponding to the determined location and a plurality of characters surrounding the target character;
magnify the identified subset of the plurality of characters on the touch screen;
visually distinguish the target character from the other characters in the magnified subset;
detect release of the sustained input pressure from the user via the touch screen;
determine a location of the detected release relative to the magnified subset of characters; and
select one of the magnified subset of characters based on the determined location.

2. The system of claim 1, wherein the received sustained input pressure corresponds to the user holding a pointing device against the touch screen.

3. The system of claim 1, wherein the processor is programmed to visually distinguish the target character by magnifying the target character at a higher level than the other characters in the identified subset.

4. The system of claim 1, wherein the sustained input pressure comprises tactile input.

5. The system of claim 1, wherein the processor is programmed to magnify the identified subset of the plurality of characters by linearly magnifying the identified subset.

6. The system of claim 1, further comprising means for improving the accuracy of character input by the user on the mobile device via the touch screen, and means for determining the plurality of characters directly or indirectly surrounding the target character.

7. A method comprising:
displaying a visual representation of a plurality of characters on at least a portion of a touch screen associated with a computing device;
receiving a first input from a user via the touch screen;
determining a location of the received first input relative to the displayed visual representation of the plurality of characters;
identifying a target character from the displayed plurality of characters based on the determined location;
selecting a plurality of non-alphanumeric characters based at least on the identified target character;
magnifying the identified target character and the selected plurality of non-alphanumeric characters relative to the displayed visual representation;
visually distinguishing the magnified target character from the magnified plurality of non-alphanumeric characters;
receiving a second input from the user via the touch screen;
determining a location of the received second input relative to the magnified target character and magnified plurality of non-alphanumeric characters; and
selecting the target character or one of the magnified plurality of non-alphanumeric characters as an intended character based on the determined location.

8. The method of claim 7, wherein selecting the plurality of non-alphanumeric characters comprises selecting a plurality of symbols based on one or more of the following: linguistic probabilities associated with the target character, frequency of use of the symbols, and whether the target character is a letter or a number.

9. The method of claim 7, further comprising selecting a plurality of alphanumeric characters based at least on the identified target character and magnifying the selected plurality of alphanumeric characters for display via the touch screen.

10. The method of claim 7, further comprising modifying the selected plurality of non-alphanumeric characters based at least on the intended character.

11. The method of claim 10, wherein the intended character completes a sentence entered by the user, and wherein modifying the selected plurality of non-alphanumeric characters comprises including end-of-sentence punctuation symbols in the selected plurality of non-alphanumeric characters.

12. The method of claim 7, wherein receiving the first input comprises detecting an object hovering over the touch screen, and wherein receiving the second input comprises receiving tactile input from the user.

13. The method of claim 7, wherein magnifying the identified target character and the selected plurality of non-alphanumeric characters comprises magnifying the target character at a first magnification level and magnifying the selected plurality of non-alphanumeric characters at a second magnification level.

14. The method of claim 7, further comprising automatically displaying, responsive to said selecting, the visual representation of the plurality of characters without the magnified target character and the magnified plurality of non-alphanumeric characters.

15. The method of claim 7, further comprising receiving a third input from the user via the touch screen, said received third input corresponding to a command to remove the magnification, and removing the magnification responsive to the received third input.

16. The method of claim 7, further comprising receiving additional input selecting one or more of the following after said selecting: the target character, and one of the magnified plurality of non-alphanumeric characters.

17. The method of claim 7, wherein the first input corresponds to tactile pressure and the second input corresponds to release of the tactile pressure.

18. One or more computer-readable media having computer-executable components, said components comprising:
a configuration component for enabling a user of a computing device having a touch screen to provide magnification settings associated with a visual representation of a plurality of characters;
an interface component for displaying the visual representation of a plurality of characters on at least a portion of the touch screen, said interface component further receiving a first input from a user via the touch screen;
a segment component for identifying a target character from the displayed plurality of characters based on the input received by the interface component, said segment component further selecting a subset of the plurality of characters based at least on the identified target character, said selected subset including the identified target character; and
a zoom component for magnifying the subset of characters selected by the segment component according to the magnification settings from the configuration component, wherein the interface component receives a second input from the user via the touch screen, and wherein the segment component selects at least one of the magnified subset of characters based on the second input received by the interface component.

19. The computer-readable media of claim 17, wherein the zoom component further visually distinguishes the target character from the other characters in the magnified subset.

20. The computer-readable media of claim 17, wherein the interface component further detects a direction of the first input relative to the visual representation, and wherein the segment component selects the subset of the plurality of characters based on the detected direction.
